(19) United States
(12) Patent Application Publication
(10) Pub. No.: US 2009/0007373 A1
(43) Pub. Date: Jan. 8, 2009

(54) Hinge barrel and manufacturing method thereof

(75) Inventor: Ding-Hone Su, Xizhi City (TW)

Correspondence Address: Joe McKinney Muncy, PO Box 1364, Fairfax, VA, 22038-1364, US

(73) Assignee: Sinher Technology Inc., Xizhi City (TW)

(21) Appl. No.: 11/892,765

(22) Filed: Aug. 27, 2007

Related U.S. Application Data
(63) Continuation-in-part of application No. 11/822,258, filed on Jul. 3, 2007.

(51) Int. Cl. E05D 7/00; B21K 13/02

(52) U.S. Cl. 16/221; 29/11

(57) ABSTRACT

The present invention includes fabricating a raw metal through a first rolling process to form a body having a base, a bracing portion and a holding trough; placing a forming strut in the holding trough; fabricating the body held the forming strut through a second rolling process to form the bracing portion in an arched shape with the inner side in contact with the forming strut; treating the body with the arched bracing portion and the forming strut in a heat treatment to enhance the hardness; and cutting off the body at a selected length and removing the forming strut to become a finished product of the hinge barrel. The hinge barrel thus formed can provide a required steady friction coefficient. It is simply structured and can be fabricated with a lower force. The probability of product defects resulting from too much or too little friction coefficient can be prevented.

### FIELD OF THE INVENTION

The present invention relates to a hinge barrel and a manufacturing method thereof and particularly to a hinge barrel made from metal that has a holding trough and a manufacturing method thereof.

### BACKGROUND OF THE INVENTION

Many 3C electronic devices such as personal digital assistants (PDAs), digital cameras, mobile phones and the like have a display and a host coupled together through a hinge. When in use the display is lifted and extended. When not in use the display can be folded onto the host to reduce the size to facilitate storing and carrying.

The main concern of the design of the hinge is to provide a torsional force so that the display and the host can be coupled together and also can be extended relative to each other. Moreover, when the display and the host are extended at a selected position it should not be easily changed under an external force.

R.O.C. patent No. M249418, entitled “Pintle structure” discloses a pintle structure to control opening and folding of two articles. It has a pintle with a chamfered surface on the surface and a plurality of washers each having a pintle hole with an opening to receive the pintle. The pintle hole has a tangent surface corresponding to the chamfered surface. When the pintle is turned in the pintle hole a friction force is generated to provide a torsional force for the two articles to open and close. When the chamfered surface is mating the tangent surface the torsional force is released to provide an anchoring effect.

The pintle structure set forth above needs a lot of elements, including many washers to generate the required torsional force. The anchoring is accomplished by mating the chamfered surface of the pintle and the tangent surface of the washers. The anchoring effect is not desirable. Furthermore, the incessant turning of the pintle in the pintle hole of the washers tends to wear off the chamfered surface and the tangent surface. The tightness between the pintle and the washers could decrease. The torsional force being generated could be affected.

R.O.C. patent No. M251049, entitled “Hinge for multifunctional peripherals and lid thereof” has a coupling portion located at one end of an elastic structure and a pivotal connecting portion at another end of the elastic structure. It can be hinged on a lid body in a rotary manner. There is a gap between the pivotal connecting portion and the coupling portion. When the lid body is opened it gives the pivotal connecting portion a push force. The elastic structure releases an elastic force to change the gap between the pivotal connecting portion and the coupling portion. Thereby the lid body can be opened or closed through the hinge structure.

However, the hinge structure set forth above can only provide anchoring of the lid body at an opening and a closing positions. It cannot be adjusted at any position according to user's requirements. Moreover, elastic fatigue tends to occur to the elastic structure after used for a period of time or when not in use properly. The elastic structure could be broken when exceeding an allowable elastic range. All these issues are pending to be resolved in the industry.

### SUMMARY OF THE INVENTION

The primary object of the present invention is to solve the aforesaid problems. The present invention provides a hinge barrel and a manufacturing method thereof. The hinge barrel is made of a metal of a good extensibility and a lower cost, and produced through a novel fabrication process. The resulting hinge barrel has a required stable friction coefficient. The structure is simpler. The probability of forming the hinge barrel with too much or too little friction coefficient due to an improper applying force during the manufacturing process decreases.

The method for manufacturing the hinge barrel of the invention includes the following steps:

providing a raw metal;

fabricating the metal through a first rolling process through a first rolling machine to form a body consisting of a base, a bracing portion and a holding trough;

placing a forming strut in the holding trough;

fabricating the body held the forming strut through a second rolling process through a second rolling machine to make an inner side of the bracing portion in contact with the forming strut to become an arched shape;

treating the body formed with the arched bracing portion and the forming strut through a heat treatment, and cutting the body at a selected length; and

removing the forming strut to form a finished product of the hinge barrel.

It is another object of the invention to provide a hinge barrel that generates a friction force during turning and provides a required torsional force while an active end and a passive end are extended relative to each other.

The structure of the invention includes a body which has a bracing portion with an opening and a base adjacent to the bracing portion. The bracing portion has a holding trough formed substantially in an arched shape.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flow chart of the manufacturing method of the invention.

FIGS. 2 through 8 are perspective views and sectional views according to the manufacturing method of the invention.

FIG. 9 is another flow chart of the manufacturing method of the invention.

FIG. 10 is a schematic view of an embodiment of the invention.

FIG. 11 is a schematic view of another embodiment of the invention.

FIG. 12 is a schematic view of yet another embodiment of the invention.

### DETAILED DESCRIPTION OF THE PREFERRED EMBODIMENTS

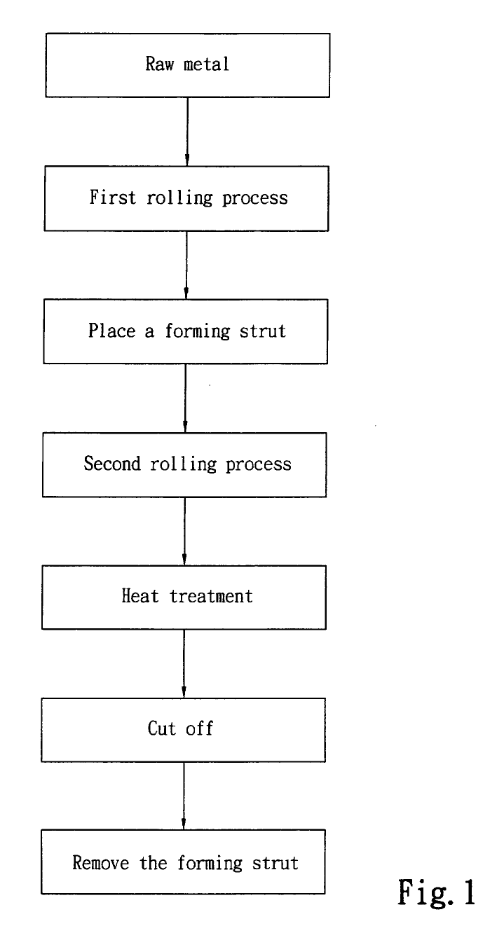

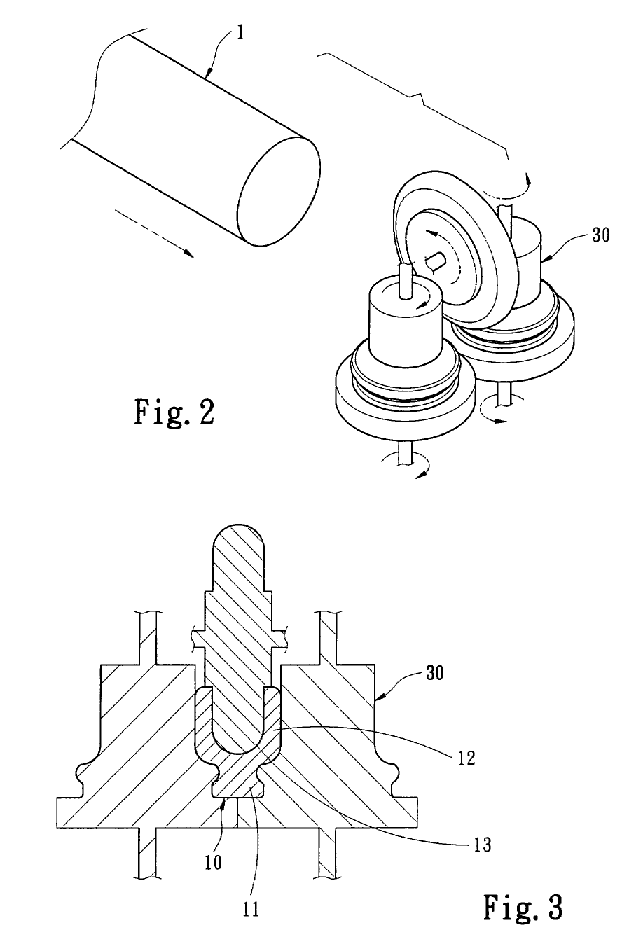

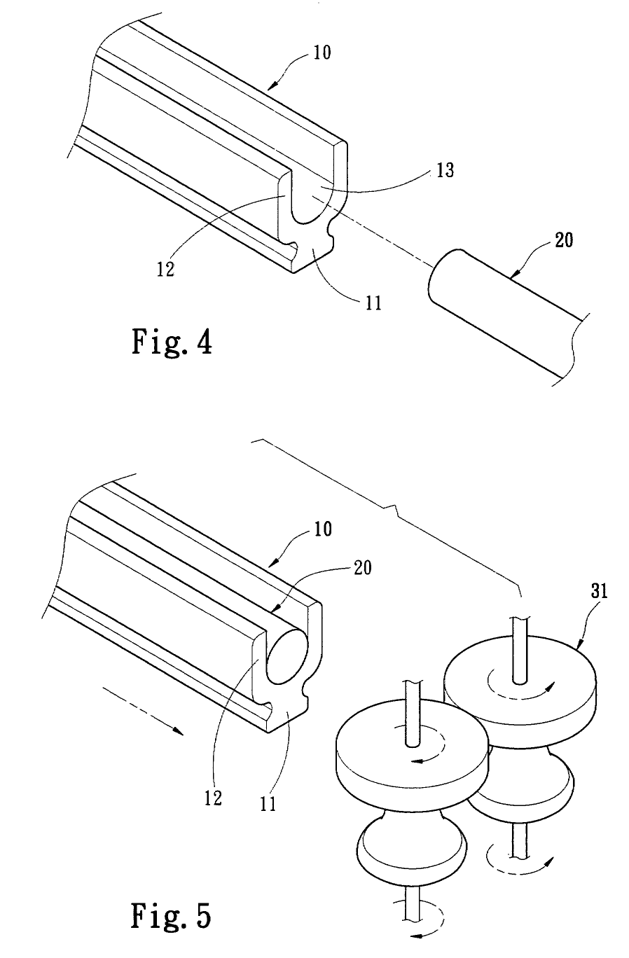

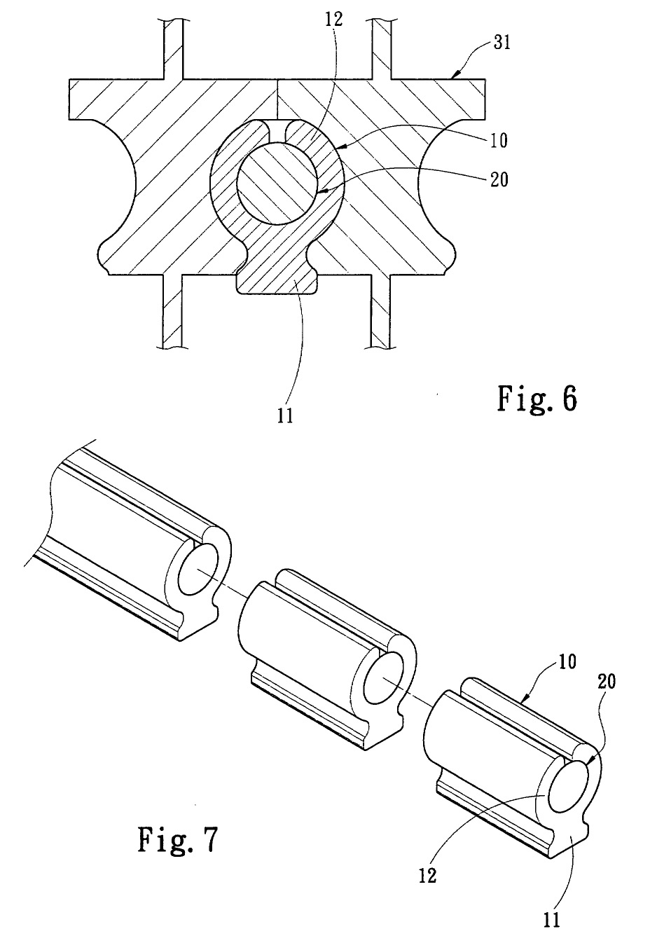

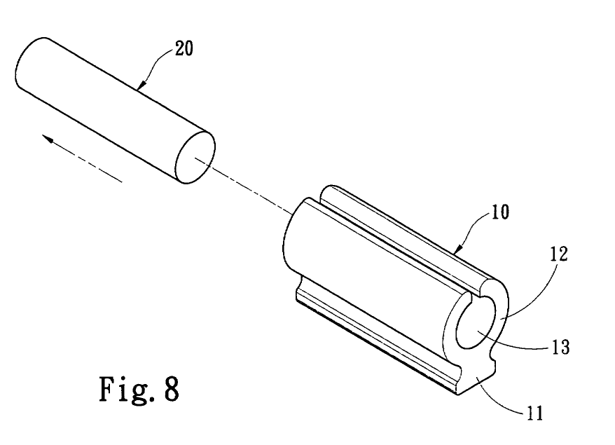

Please refer to FIG. 1 for a process procedure of the manufacturing method of the invention to form hinge barrels. First, a raw metal 1 is selected as the material of the hinge barrel. The raw metal 1 is fabricated through a first rolling process through a first rolling machine 30 which has a pair of corresponding first rollers and an upper roller to form a body 10 consisting of a base 11, a bracing portion 12 and a holding trough 13 (also referring to FIGS. 2 and 3). Then a forming strut 20 is placed in the holding trough 13 (referring to FIG. 4). Put the body 10 held the forming strut 20 through a second rolling process through a second rolling machine 31 which has a pair of corresponding second rollers so that an inner side of the bracing portion 12 is in contact closely with the outer surface of the forming strut 20 to form an arched shape (referring to FIGS. 5 and 6). The body 10 thus formed with the outer surface of the forming strut 20 in contact with the inner side of the bracing portion 12 is treated in a heat treatment process to enhance the hardness. Afterward the body 10 is cut off according to a desired length (referring to FIG. 7); Finally, remove the forming strut 20 from the body 10 to become a finished product of the hinge barrel of the invention (referring to FIG. 8).

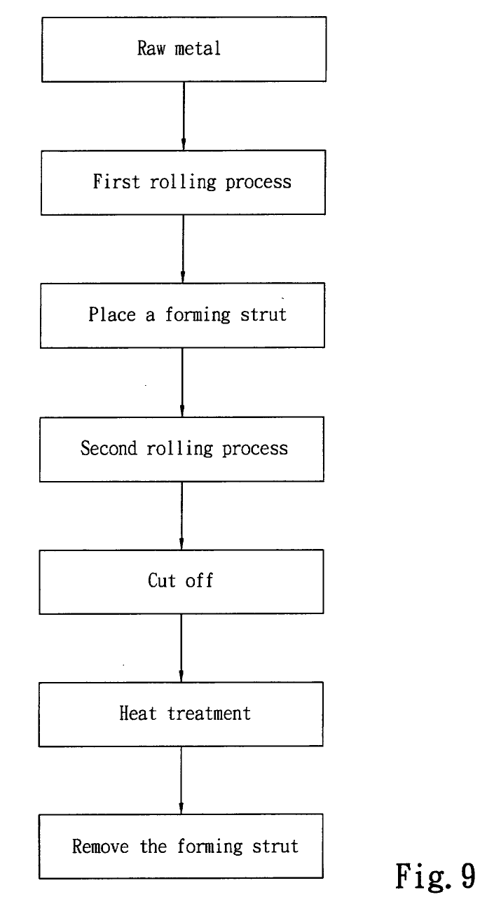

Refer to FIG. 9 for another process procedure of the manufacturing method of the invention to form the hinge barrels. It differs from the procedure previously discussed by having the body 10 cut off at a selected length after the second rolling process with the bracing portion 12 holding the forming strut 20 tightly, then treating the body 10 in a heat treatment process to enhance the hardness. Afterward the forming strut 20 is removed from the holding trough 13 to become the finished product of the hinge barrel. By means of the method set forth above, the hinge barrel can be formed at a simpler manufacturing procedure at a lower production cost. It also can generate a friction force during turning of the hinge barrel to provide a torsional force required while an active end and a passive end of hinge barrel are extended relative to each other. The hinge barrel fabricated through the method previously discussed includes a body 10 which has a bracing portion 12 with an opening and a base 11 adjacent to the bracing portion 12. The bracing portion 12 has a holding trough 13 formed in an arched shape at an inner diameter equal to the outer diameter of the forming strut 20.

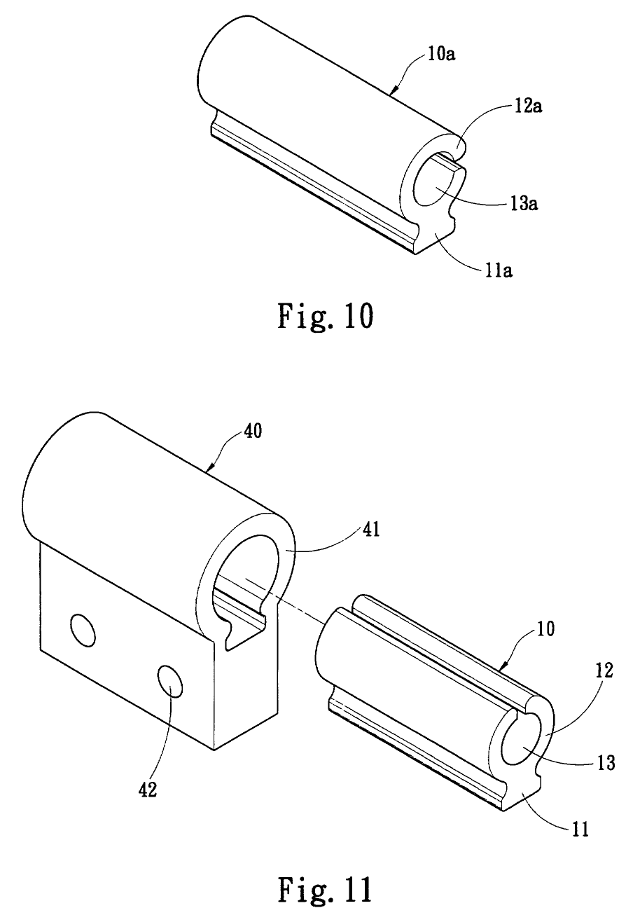

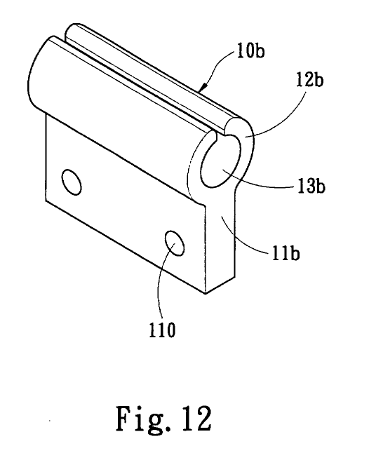

Refer to FIG. 10 for an embodiment of the invention. In this embodiment a bracing portion 12a of a body 10a is asymmetrical without restricting the direction of the opening. The body 10a also has a base 11a, the bracing portion 12a and a holding trough 13a to provide a needed steady friction coefficient and a torsional force required during turning of the hinge barrel. FIG. 11 illustrates another embodiment of the invention in which the body 10 is held in a holding trough 41 formed in a fastening seat 40 in an integrated manner. The fastening seat 40 has a fastening hole 42 to receive a fastening element such as a screw to be fastened to a targeted article (not shown in the drawings). FIG. 12 depicts yet another embodiment of the invention in which a body 10b has a base 11b with a fastening hole 110 formed thereon to be fastened to a targeted article. The body 10b also has a bracing portion 12b and a holding trough 13b.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing a hinge barrel, comprising the steps of
providing a raw metal;
fabricating the metal through a first rolling process to form a body which has a base, a bracing portion and a holding trough;
placing a forming strut in the holding trough;
fabricating the body held the forming strut through a second rolling process to make an inner side of the bracing portion in contact with the forming strut to become an arched shape;
treating the body formed with the arched bracing portion and the forming strut through a heat treatment, and cutting the body at a selected length; and
removing the forming strut to form a finished product of the hinge barrel.

2. The method of claim 1, wherein the first rolling process is accomplished through a first rolling machine which has a pair of corresponding first rollers and an upper roller.

3. The method of claim 1, wherein the second rolling process is accomplished through a second rolling machine which has a pair of corresponding second rollers.

4. A method for manufacturing a hinge barrel, comprising the steps of
providing a raw metal;
fabricating the metal through a first rolling process to form a body which has a base, a bracing portion and a holding trough;
placing a forming strut in the holding trough;
fabricating the body held the forming strut through a second rolling process to make an inner side of the bracing portion in contact with the forming strut to become an arched shape;
cutting the body at a selected length and treating the body formed with the arched bracing portion and the forming strut through a heat treatment; and
removing the forming strut to form a finished product of the hinge barrel.

5. The method of claim 4, wherein the first rolling process is accomplished through a first rolling machine which has a pair of corresponding first rollers and an upper roller.

6. The method of claim 4, wherein the second rolling process is accomplished through a second rolling machine which has a pair of corresponding second rollers.

7. A hinge barrel comprising:
a body including a bracing portion which has an opening and a base adjacent to the bracing portion, the bracing portion having an arched interior to form a holding trough.

8. The hinge barrel of claim 7, wherein the holding trough has an inner diameter the same as the outer diameter of a forming strut.

9. The hinge barrel of claim 7, wherein the base has a fastening hole.

10. The hinge barrel of claim 7, wherein the bracing portion is asymmetrical.

11. The hinge barrel of claim 7, wherein the body is held in another holding trough of a fastening seat to become an integrated manner.
